(19) United States
(12) Patent Application Publication
(10) Pub. No.: US 2008/0108735 A1
(43) Pub. Date: May 8, 2008

(54) Method For Treating Phthalocyanine Pigments For the Weatherable and Light-Resisting Pigmentation of Plastic Materials

(76) Inventors: Matthias Ganschow, Wiesbaden (DE); Carsten Plueg, Seeheim-Jugenheim/Ober-Beerbach (DE); Hans Joachim Metz, Frankfurt am Main (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/792,774

(22) PCT Filed: Nov. 15, 2005
(86) PCT No.: PCT/EP05/12206

§ 371 Date: Jun. 8, 2007

(30) Foreign Application Priority Data
Dec. 11, 2004 (DE) 10 2004 059 863.0

(51) Int. Cl. C09B 67/50; C08K 5/3467; C09B 47/04

(52) U.S. Cl. 524/88; 106/410; 540/122

(57) ABSTRACT

A method for treating phthalocyanine pigments, said method being characterized in that a) a phthalocyanine pigment is suspended in a liquid medium containing aqueous hydrochloric acid and an organic solvent containg carbonyl and/or ether groups, b) the suspension is maintained for between 5 to 300 min at a temperature of from 0° to 150° C. and c) the suspension is then filtered and washed.

Method for treating phthalocyanine pigments for the weatherable and light-resisting pigmentation of plastic materials

When plastics, in particular PVC, have been pigmented with phthalocyanine pigments, a prolonged period of weathering often leads to formation of brownish-black discolored areas in the plastic. These discolored areas are possibly brought about by degradation reactions catalyzed by contaminants present in trace quantities in the pigment. These contaminants pass into the pigments either by way of the raw materials or catalysts used or as a consequence of a process.

It was therefore an object of the present invention to develop a process which can treat phthalocyanine pigments which are suitable for weather-resistant and lightfast pigmentation of plastics, in particular of PVC, without altering the coloristic properties of the pigments.

Surprisingly, it has been found that the process described below achieves this object.

The invention provides a process for treating phthalocyanine pigments, which comprises
a) suspending, if appropriate in the presence of auxiliaries, a phthalocyanine pigment in a liquid medium which comprises aqueous hydrochloric acid and comprises an organic solvent in which carbonyl and/or ether groups are present,
b) keeping the suspension at a temperature of from 0° to 150° C., preferably 40 to 90° C. for from 5 to 300 min, preferably from 20 to 120 min, and
c) then filtering and washing the suspension.

The pigments thus treated are generally then dried and finished in a manner appropriate to the application sector.

Phthalocyanine pigments that can be used are metallic, metal free, halogenated, and non-halogenated phthalocyanines, examples being C.I. Pigment Blue 15, 15:1, 15:2, 15:3, 15:4, 15:6, C.I. Pigment Green 7 or 36.

The pigments are generally used in dry form, as crude pigment or finished pigment. However, use in the form of press cake comprising water or comprising solvent is also possible.

For the inventive treatment, it is advantageous to use from 0.01 to 0.5 part by weight, in particular from 0.05 to 0.15 part by weight, of pigment, based on one part by weight of liquid medium.

The form in which the hydrochloric acid is used is advantageously that of aqueous HCl of strength from 5 to 35% by weight, in particular from 15 to 25% by weight.

The organic solvent used is an organic solvent containing a carbonyl function and/or ether function, preferably aliphatic, aromatic, or araliphatic ketones, aldehydes, ethers, or glycol ethers, examples being:
C₃-C₁₅ ketones, e.g. methyl ethyl ketone, methyl isopropyl ketone, methyl isobutyl ketone, ethyl sec-butyl ketone, methyl-tert-butyl ketone, methyl isoamyl ketone, diethyl ketone, ethyl amyl ketone, diisopropyl ketone, diisobutyl ketone, mesityl oxide, or cyclohexanone
di(C₂-C₁₅)-alkyl ethers or cycloalkyl ethers, e.g. diethyl ether, tetrahydrofuran, 3-methyltetrahydrofuran, or pentamethylene oxide
di-, tri-, and tetra-C₂-C₄-alkylene glycols, e.g. di-, tri-, and tetraethylene glycol, or di-, tri-, and tetrapropylene glycol,
C₂-C₄-alkylene glycol mono-C₁-C₆-alkyl ethers and the corresponding di-C₁-C₆-alkyl ethers, and their di-, tri-, and tetra-C₂-C₄-alkylene glycols, e.g. ethylene glycol monobutyl ether and the corresponding monohexyl ether, propylene glycol monobutyl ether and the corresponding monohexyl ether, ethylene glycol dimethyl, diethyl, dipropyl, diisopropyl, and dibutyl ether, propylene glycol dimethyl, diethyl, dipropyl, diisopropyl, and dibutyl ether, di-, tri-, and tetraethylene glycol monomethyl, monoethyl, and monobutyl ether, di-, tri-, and tetraethylene glycol dimethyl, diethyl, and dibutyl ether, di-, tri-, and tetrapropylene glycol monomethyl, monoethyl, and monobutyl ether, di-, tri-, and tetrapropylene glycol dimethyl, diethyl, and dibutyl ether,
   and their mixtures.

Among the organic liquids, preference is given to those which are not miscible with the aqueous liquid comprising hydrochloric acid. This permits easy separation, and return to the process, of the lower- or higher-density organic phase of the filtrate.

Another factor to be considered during selection of the organic liquids is that they do not enter into any chemical reactions with the other components. The amount preferably used of the organic solvent is from 0.05 to 5 parts by weight, in particular from 0.5 to 1.5 parts by weight, based on one part by weight of aqueous hydrochloric acid.

Alongside the constituents mentioned, it is also possible to add from 0 to 0.5 part by weight, preferably from 0.01 to 0.1 part by weight, based on one part by weight of the suspension, of at least one other auxiliary from the group of the surfactants, non-pigmentary and pigmentary dispersing agents, antifoams, wetting agents, alcohols, antioxidants, UV absorbers, waxes, and light stabilizers.

The inventively treated phthalocyanines can be used for coloring polymers, such as PVC, polyolefins, PA, PUR, PMMA, polyester, or PVC, preferably for coloring PVC, and known processes are used here for pigmentation, if appropriate via addition of additives and auxiliaries known to the person skilled in the art, e.g. via injection molding, extrusion, or hot-roll processes. The inventively treated phthalocyanine pigment here can be used in the form of powder or pellets or masterbatch, or in the form of a preparation.

In particular, PVC pigmented with the inventively treated phthalocyanine can be used for producing window profiles, floorcoverings, or packaging, e.g. of food or drink, or else can be used for pipes for drainage, drinking-water lines, waste-water lines, cable ducts, and electrical installations, or else PVC foils.

The present invention therefore also provides a plastic pigmented with the inventively treated phthalocyanine pigment, preferably PVC, polyolefins, PA, PUR, PMMA or polyester.

### EXAMPLE 1

15 g of C.I. Pigment Blue 15:3 were dispersed in a mixture composed of 150 ml of hydrochloric acid (6 molar) and 150 ml of methyl isobutyl ketone (MIBK) for 15 min and then stirred at 90° C. for 30 min. After cooling, stirring was continued with ice-bath cooling for 30 min, and the suspension was filtered and washed with 50 ml of methyl isobutyl ketone, 100 ml of hot water (about 70° C.), and 50 ml of methanol. The resultant press cake was dried in a vacuum drying cabinet at 80° C. for 12 h and ground.

The purified pigment exhibits unaltered coloristic properties.

### EXAMPLE 2

15 g of C.I. Pigment Blue 15:3 were dispersed in a mixture composed of 150 ml of hydrochloric acid (6 molar) and 150 ml of methyl isobutyl ketone for 15 min and then stirred at 40° C. for 30 min. After cooling, stirring was continued with ice-bath cooling for 30 min, and the suspension was filtered and washed with 50 ml of methyl isobutyl ketone, 100 ml of hot water (about 70° C.), and 50 ml of methanol. The resultant press cake was dried in a vacuum drying cabinet at 80° C. for 12 h and ground.

The purified pigment exhibits unaltered coloristic properties.

### EXAMPLE 3

15 g of C.I. Pigment Blue 15:3 were dispersed in a mixture composed of 150 ml of hydrochloric acid (6 molar) and 150 ml of diethylene glycol dimethyl ether for 15 min and then stirred at 90° C. for 30 min. After cooling, stirring was continued with ice-bath cooling for 30 min, and the suspension was filtered and washed with 50 ml of diethylene glycol dimethyl ether (DGDME), 100 ml of hot water (about 70° C.), and 50 ml of methanol. The resultant press cake was dried in a vacuum drying cabinet at 80° C. for 12 h and ground.

The purified pigment exhibits unaltered coloristic properties.

### EXAMPLE 4

20 g of C.I. Pigment Green 7 were purified by analogy with example 1. The purified pigment exhibits unaltered coloristic properties.

### APPLICATION EXAMPLES

### EXAMPLE 5

100 parts of a PVC mixture in powder form are mixed with 0.1 part of pigment from example 1 in a vessel for 10 minutes. The mixture is then charged to a roll mill and plastified at 130° C. (roll-surface temperature) and converted to a peelable form. After roll-milling, a rectangular piece is cut off from the milled sheets peeled from the roll and weathered to DIN EN ISO 4892 (filtered xenon-arc radiation, simultaneous weathering, equipment: Atlas Weather-Ometer).

After weathering to DIN EN ISO 4892 for 8000 hours, no brownish-black discolored areas arise in the plastic, unlike with Pigment Blue 15:3 which has not been inventively treated.

### EXAMPLE 6

By analogy with example 5, a PVC foil is produced with the pigment from example 2 and weathered. After weathering to DIN EN ISO 4892 for 8000 hours, no brownish-black discolored areas arise in the plastic, unlike with Pigment Blue 15:3 which has not been inventively treated.

### EXAMPLE 7

By analogy with example 5, a PVC foil is produced with the pigment from example 3 and weathered. After weathering to DIN EN ISO 4892 for 8000 hours, no brownish-black discolored areas arise in the plastic, unlike with Pigment Blue 15:3 which has not been inventively treated.

### EXAMPLE 8

By analogy with example 5, a PVC foil is produced with the pigment from example 4 and weathered. After weathering to DIN EN ISO 4892 for 8000 hours, no brownish-black discolored areas arise in the plastic, unlike with Pigment Green 7 which has not been inventively treated.

1) A process for treating a phthalocyanine pigment comprising the steps of:
a) suspending a phthalocyanine pigment in a liquid medium, wherein the liquid medium includes aqueous hydrochloric acid and an organic solvent, wherein the organic solvent includes at least one of carbonyl or ether groups to form a suspension,
b) keeping the suspension at a temperature of from 0° to 150° C. for from 5 to 300 min, and
c) filtering and washing the suspension.

2) The process as claimed in claim 1, wherein the phthalocyanine pigment is C.I. Pigment Blue 15, 15:1, 15:2, 15:3, 15:4, 15:6, C.I. Pigment Green 7 or 36.

3) The process as claimed in claim 1, wherein the amount of pigment present, based on one part by weight of liquid medium, is from 0.01 to 0.5 part by weight.

4) The process as claimed in claim 1, wherein the organic solvent is selected from the group consisting of aliphatic, aromatic, or araliphatic ketones, aldehydes, ethers, and glycol ethers.

5) The process as claimed in claim 1, wherein the organic solvent is selected from the group consisting of C₃-C₁₅ ketones, di(C₂-C₁₅)-alkyl ethers or cycloalkyl ethers, di-, tri- and tetra-C₂-C₄-alkylene glycols, C₂-C₄-alkylene glycol mono-C₁-C₆-alkyl ethers and the corresponding -di-C₁-C₆-alkyl ethers, and di-, tri-, and tetra-C₂-C₄-alkylene glycols.

6) The process as claimed in claim 1, wherein the amount of organic solvent present is from 0.05 to 5 parts by weight, based on one part by weight of aqueous hydrochloric acid.

7) The process as claimed in claim 1, further comprising from 0 to 0.5 part by weight of at least one auxiliary, based on one part by weight of the suspension, wherein the at least one auxiliary is added, selected from the group consisting of the surfactants, non-pigmentary and pigmentary dispersing agents, antifoams, wetting agents, alcohols, antioxidants, UV absorbers, waxes, and light stabilizers.

8) The process as claimed in claim 1, wherein the suspension is kept at a temperature of from 40 to 90° C.

9) A plastic pigmented with a phthalocyanine pigment as claimed in claim 11.

10) A PVC pigmented with a phthalocyanine pigment claimed in claim 11.

11) A phthalocyanine pigment treated in accordance with the process according to claim 1.
